(19) United States
(12) Patent Application Publication
(10) Pub. No.: US 2026/0360143 A1
(43) Pub. Date: Nov. 12, 2026

(54) INFLIGHT ENTERTAINMENT SYSTEM IDENTIFYING PASSENGERS AND DELIVERING PERSONALIZED PASSENGER INFORMATION TO CREW MEMBERS THROUGH AUGMENTED REALITY HEADSETS

(71) Applicant: Thales Avionics, Inc., Irvine, CA (US)

(72) Inventors: Yann NICOLAS, Melbourne, FL (US); Michael DIPPOLD, Fullerton, CA (US)

(21) Appl. No.: 19/203,937

(22) Filed: May 9, 2025

(51) Int. Cl. G06V 20/20; G06Q 20/24; G06T 11/00; G06V 10/75; G06V 20/40; G06V 40/16

(52) U.S. Cl. CPC G06V 20/20; G06Q 20/24; G06T 11/00; G06V 10/75; G06V 20/40; G06V 40/168; G06V 40/172

(57) ABSTRACT

An IFE system including an IFE controller and an AR device manager. The IFE controller operative to route entertainment content through at least one cabin communication network to SVDUs and/or to PEDs. The AR device manager operative to determine location of an AR device relative to physical features of the cabin, to identify a passenger in video captured by a camera of the AR device based on the determined location of the AR device, and to provide the identity of the passenger and the determined location of the AR device to the IFE controller. The IFE controller is operative to obtain passenger information based on the identity of the passenger, to generate AR information based on the passenger information and the determined location of the AR device, and to communicate the AR information to the AR device for display as an augmented reality image.

### TECHNICAL FIELD

The present disclosure relates to inflight entertainment systems and their operation with various types of mobile electronic devices that can be used during flights.

### BACKGROUND

Cabin crew members are being tasked with an increasing number of responsibilities during flights, reflecting a shift towards enhancing both safety and passenger experience. Beyond their traditional roles, crew members now conduct comprehensive pre-flight safety checks, ensuring that all emergency equipment is in working order and that the cabin is secure. Moreover, there is a growing emphasis on personalized service within the cabin. Crew members are encouraged to address passengers by their names, creating a more welcoming and personalized atmosphere. They are trained to become aware of passengers' preferences and special needs, such as dietary restrictions, mobility assistance, or specific requests, and to offer proactive assistance throughout the flight.

This approach not only aims to provide a more comfortable and enjoyable experience for passengers but also helps to build a stronger rapport between the crew and passengers. By combining these enhanced safety measures with personalized service, airlines strive to maintain high standards of efficiency while significantly improving the overall passenger experience.

### SUMMARY

Various embodiments are directed to an IFE system including an IFE controller and an AR device manager. The IFE controller operative to route entertainment content through at least one cabin communication network to seat video display units (SVDUs) and/or to portable electronic devices (PEDs). The augmented reality (AR) device manager operative to determine location of an AR device relative to physical features of the cabin, to identify a passenger in video captured by a camera of the AR device based on the determined location of the AR device, and to provide the identity of the passenger and the determined location of the AR device to the IFE controller. The IFE controller is further operative to obtain passenger information based on the identity of the passenger, to generate AR information based on the passenger information and the determined location of the AR device, and to communicate the AR information through the at least one cabin communication network to the AR device for display as an augmented reality image overlaid on a real-world image viewed through the AR device.

Other related embodiments are directed to a method performed by an aircraft inflight entertainment IFE system including an IFE controller and AR device manager. The method includes the IFE controller routing entertainment content through at least one cabin communication network to SVDUs and/or to PEDs. The method also includes the AR device manager determining location of an AR device relative to physical features of the cabin, to identify a passenger in video captured by a camera of the AR device based on the determined location of the AR device, and to provide the identity of the passenger and the determined location of the AR device to the IFE controller. The method also includes the IFE controller is further operative to track types of services provided by crew members to the identified passengers, update the log file based on the tracked services, prioritize future assignment of which crew members are to provide which of the types of services to which of the passengers based on the log file, and generate AR information distributed to AR devices worn by the crew members indicating which types of services are assigned to individual ones of the crew members to provide to indicated ones of the passengers.

Other vehicle entertainment systems and corresponding methods and computer program products according to embodiments of the invention will be or become apparent to one with skill in the art upon review of the following drawings and detailed description. It is intended that all such additional systems, methods, and computer program products be included within this description, be within the scope of the present invention, and be protected by the accompanying claims. Moreover, it is intended that all embodiments disclosed herein can be implemented separately or combined in any way and/or combination.

### BRIEF DESCRIPTION OF THE DRAWINGS

The accompanying drawings, which are included to provide a further understanding of the disclosure and are incorporated in a constitute a part of this application, illustrate certain non-limiting embodiments of inventive concepts. In the drawings:

FIG. 1 illustrates a component block diagram of an aircraft IFE system with mobile AR headsets and an AR headset manager, a satellite communication network, and a ground system, which are configured to operate in accordance with various embodiments of the present disclosure;

FIG. 2 illustrates an example of an aircraft cabin environment and AR headset localization features in accordance with various embodiments of the present disclosure;

FIG. 3 illustrates an example illustration of an overhead view of an aircraft cabin environment where RF positioning is being performed to assist the AR headset manager in determining the location of the AR headset in accordance with various embodiments of the present disclosure;

FIG. 4 provides an illustration of reference axes which the AR headset cabin positioning model defines in the cabin based on seat placards and arrangement of seats and aisles in accordance with various embodiments of the present disclosure;

FIGS. 5-8 illustrate example types of passenger information that could be displayed through an AR headset 142 to assist crew members providing services to passengers, according to some embodiments; and

FIG. 9 illustrates a diagram of functional modules of the IFE system, including the AR headset manager and the IFE controller, according to some embodiments.

### DETAILED DESCRIPTION

In the following detailed description, numerous specific details are set forth in order to provide a thorough understanding of example aspects of the present invention. However, it will be understood by those skilled in the art that the present invention may be practiced without these specific details. In other instances, well-known methods, procedures, components and circuits have not been described in detail so as not to obscure the present invention.

As explained above, there is a need to assist aircraft crew members with performing their duties through the use of augmented reality (AR) headsets. Airlines may provide mobile AR headsets to cabin crew members to assist them in performing their duties. The AR headsets are configured to allow crew members to view the aircraft cabin while being assisted by computer generated information which is overlaid on their view using, for example, see-through display screens (e.g., META ORION brand AR glasses). The integration of AR headsets into the daily operations of cabin crew has the potential to revolutionize in-flight service and safety procedures. AR headsets can provide real-time information overlays, allowing crew members to access passenger details, seating arrangements, and special requests without needing to consult physical documents. This hands-free access to information can enhance efficiency and ensure that passenger needs are met promptly and accurately. Additionally, AR can assist in navigation within the aircraft, highlighting emergency exits and equipment locations, thereby improving the crew's ability to respond swiftly in critical situations.

AR headsets, on the other hand, offer immersive training experiences that can significantly enhance the preparedness of cabin crew. Through AR simulations, crew members can practice emergency procedures, customer service scenarios, and routine tasks in a controlled, virtual or augmented environment. This type of training can be more effective than traditional methods, as it allows for repeated practice and immediate feedback in a risk-free setting. By experiencing a wide range of scenarios, from turbulence to medical emergencies, crew members can build confidence and competence, ensuring they are well-equipped to handle real-life situations.

AR headsets can enable cabin crew to provide more personalized service through crew immediate access to passenger preferences, pending requests, and histories. AR headsets may be used to facilitate language translation, helping crew members communicate more effectively with passengers from diverse backgrounds and/or with passengers who are hearing impaired (e.g., display sign language prompts for crew to perform). The adoption of AR by cabin crew can lead to higher levels of service, increased safety, and a more seamless and enjoyable flight experience for passengers.

Despite the numerous advantages of AR headsets for cabin crew, determining location (localization) of an AR headset in a congested cabin environment presents significant challenges. The confined space of an aircraft cabin, coupled with the movement of passengers and crew, can interfere with the ability to determine where an AR headset is located and which passenger a crew member is interacting with. For instance, AR headsets could rely on precise spatial mapping to overlay information correctly (e.g., information relevant to a passenger who a crew member is looking at), but the dynamic and crowded nature of the cabin can lead to errors in positioning and determination of relevant information for display. This can result in incorrectly determined information and/or misaligned information overlays, which may confuse the crew rather than assist.

Moreover, the physical constraints of the cabin environment can hinder the effective localization and related use of AR headsets. AR training typically requires a certain amount of space for movement and interaction, which is not available in the narrow aisles and limited space of an aircraft. These localization issues need to be addressed to fully harness the potential of AR technologies for cabin crew, ensuring that these tools enhance rather than impede their performance.

Airlines may also provide the mobile AR headsets to passengers for temporary use during a flight, for use throughout a multi-flight trip including airport layover(s) (e.g., passenger transports the AR headset from one flight to the next), and/or during a round-trip including roundtrip destinations and/or multi-city destinations (e.g., passenger keeps the AR headset for the trip duration and returns upon arrival at the home airport). Moreover, airlines can loan mobile AR headsets to passengers to temporarily try-out during a flight and/or trip with the option to buy ownership during or after the trip. Airlines can thereby improve passenger travel experience and create new ways of monetizing those experiences.

As will be described in further detail below, operational embodiments enable airlines to securely track location of AR headsets in an airline environment (e.g., localization of the AR headsets to one or more cabin location reference coordinate systems). The term location of an AR headset may indicate its spatial location (where is the AR headset spatially located with the cabin) and may further indicate its angular orientation (e.g. in what direction is the AR headset oriented relative to the cabin).

Before discussing the example operations for determining location of AR headsets in an aircraft environment, an overview is provided of example components of aircraft and ground communication systems that can be used in accordance with some embodiment of the present disclosure.

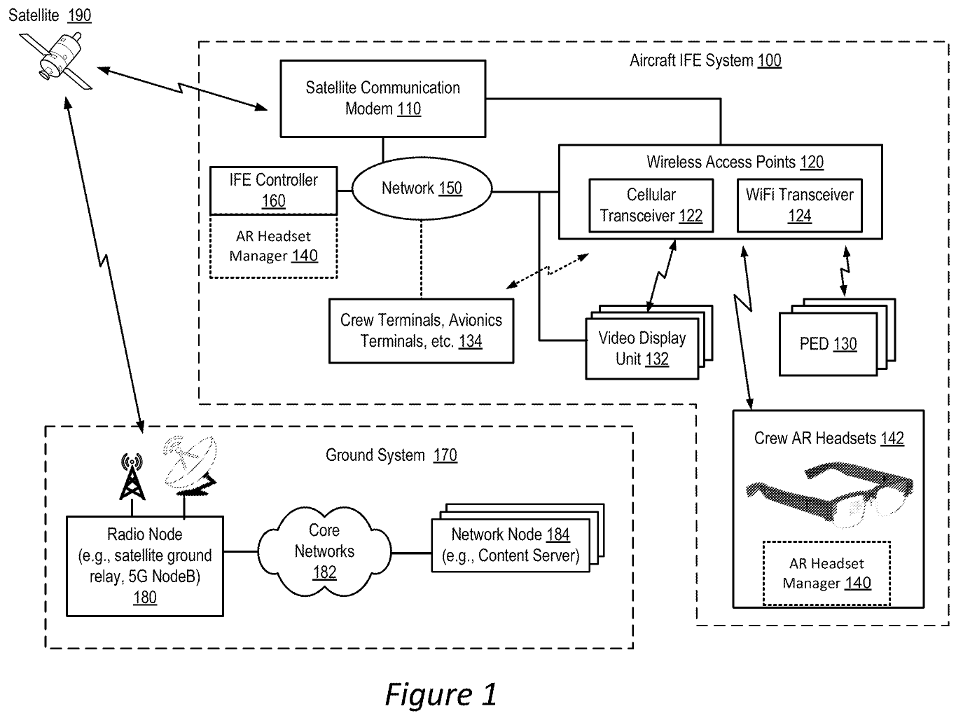

FIG. 1 illustrates a component block diagram of an aircraft IFE system 100 with mobile AR headsets 142 and an AR headset manager 140, a satellite communication network 190, and a ground system 170 which includes network nodes 184 (e.g., content servers, etc.), which are configured to operate in accordance with various embodiments of the present disclosure.

Although embodiments herein are primarily described in the context of in-flight entertainment solutions for an aircraft, the invention is not limited thereto. Instead, these and other related embodiments may be used with other types of vehicles, including, without limitation, ships (e.g., cruise ships), trains, subways, and buses. Accordingly, although various embodiments are described in the example context of involving passengers and crew, these and other embodiments can more generally be used by any persons ("users"). Accordingly, the terms passenger and user are used interchangeably without limitation.

Referring to FIG. 1, the IFE system 100 communicates with the ground system 170 using various communication technologies, e.g., proprietary satellite protocols, 3GPP 5G protocols, etc. More particularly, the example IFE system 100 includes a satellite communication modem 110 that transmits and receives signaling through one or more satellite antennas which is relayed by satellite(s) 190 to and from a ground-based radio node 180 (e.g., satellite gateway and relay, 5G NodeB, etc.).

In the IFE system 100, content received by the satellite communication modem 110 through satellite aperture antenna(s) are transported via RF link or Common Public Radio Interface (CPRI) interface (e.g., Ethernet or fiber optic links) and one or more networks 150 to an IFE controller 160 (also IFE controller) for possible distribution through the network(s) 150 and/or wireless access points 120 to SVDUs 132, passenger electronic devices (PEDs) 130, mobile AR headsets 142, crew terminals 134, and other avionics terminals. The wireless access points 120 can include WiFi transceivers 124 (e.g., IEEE 802.11) or cellular transceivers 122.

The IFE controller 160 can communicate with ground-based network nodes 184, e.g., IFE controllers (e.g., over-the-top servers providing content such as movies, TV programming, games, e-books, Internet webpages, etc.), through core networks 182 (e.g., private networks and/or public networks such as the Internet) and the radio node 180, etc. The IFE controller 160 can provide content from the network nodes 184 to the SVDUs 132, PEDs 130, and mobile AR headsets 142, and may alternatively or additionally provide similar types of content that has been previously loaded into onboard memory.

In accordance with present embodiments, the IFE controller 160 can be configured to communicate with various types of mobile AR headsets 142 to provide operational functionality to passengers. For example, the IFE controller 160 can operate to stream movies and other content to AR headsets 142, tablet computers, etc. for display and audio playout to passengers through headphones. Similarly, the IFE controller 160 may download executable applications (e.g., games) to XR headsets 142, gaming consoles, tablet computers, etc. for playing by passengers.

Passengers can thereby be provided with unique experiences which may include playing aircraft themed games through AR headsets 142 that may adapt the gameplay based on the aircraft configuration (e.g., type of aircraft and seating location of passenger), present flight location, view outside the aircraft of the surrounding airspace, ground and/or space, etc.

Through AR headsets 142, crew members can be provided with information to assist with their various tasks such as safety information, passenger information, flight information, etc.

Although the AR headset manager 140 is illustrated as a discrete box in FIG. 1 for ease of illustration and description, its functionality may be at least partially integrated within the AR headset(s) 142, the IFE controller 160, and/or one or more other electronic components of the IFE system 100. For example, an AR headset 142 may have sufficient processing throughput and memory capacity to perform operational instructions according to at least some of the functionality disclosed herein for the AR headset manager 140. The AR headset manager 140 operational functionality may therefore be implemented entirely in the AR headset 142 or the IFE controller 160 or may be implemented in-part in both the AR headset 142 and the IFE controller 160.

The AR headset manager 140 may operate to monitor establishment and maintenance of communication connections with AR headsets 142, determine location of the AR headsets 142 within the cabin, provide information for display on the AR headsets 142, etc.

For example, the AR headset manager 140 (or a component thereof in the IFE controller 160, SVDUs 132 and/or wireless access points 120) can manage setup and maintenance of Bluetooth, WiFi, or other wireless communication connections and/or wired communication (e.g., USB wired interfaces of SVDUs 132) with mobile AR headsets 142.

Alternatively, or additionally, the IFE controller 160 can operate to establish communication connections through at least one communication network (e.g., network 150, WAPs 120, SVDUs 132, etc.) with the mobile AR headsets 142 to provide vehicle entertainment services to passengers, and to route entertainment content through the communication connections to the mobile AR headsets 142 responsive to commands received from the mobile AR headsets 142.

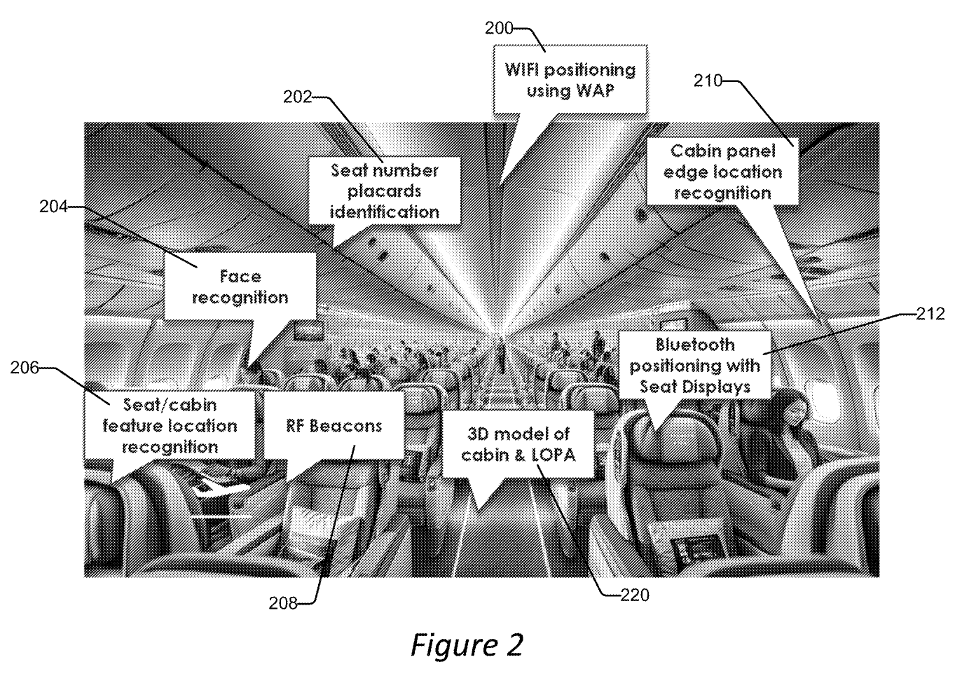

FIG. 2 illustrates an example of an aircraft cabin environment and AR headset localization features in accordance with various embodiments of the present disclosure.

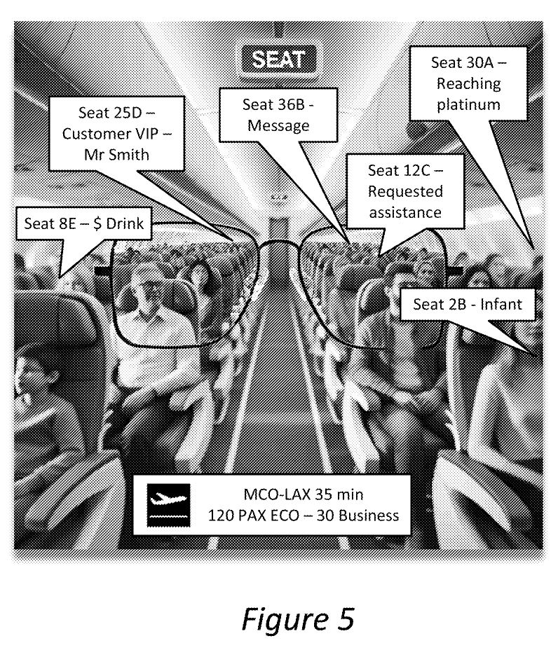

The video captured by one or more cameras integrated into the AR headset worn by a crew member is processed through an AR headset cabin positioning model 500 (see FIG. 5). The model 500 may be used by the AR headset manager to determine location of an AR headset relative to physical features of the cabin, and to provide the determined location of the AR headset to the IFE controller. The model 500 has been trained or configured using a three-dimensional (3D) model 520 (see FIG. 5) of the cabin's features which may include a Layout of Passenger Accommodations (LOPA) 220, which provides a comprehensive blueprint of the aircraft's interior. The primary function of model 500 is to determine the precise position (determined location) of the AR headset relative to various cabin features, including passenger seats. This positioning (determined location) includes not only the cabin location relative to the seats, forming a cabin reference system, but may also include the angular orientation of the AR headset, indicating the direction in which the headset is looking.

The LOPA 220 can serve as a detailed schematic of the aircraft's interior, indicating the relative arrangement of seats, galleys, lavatories, and other essential cabin features. The LOPA 220 can be used by the AR headset cabin positioning model 500 (see FIG. 5) to operate to recognize location of specific cabin features in the cabin.

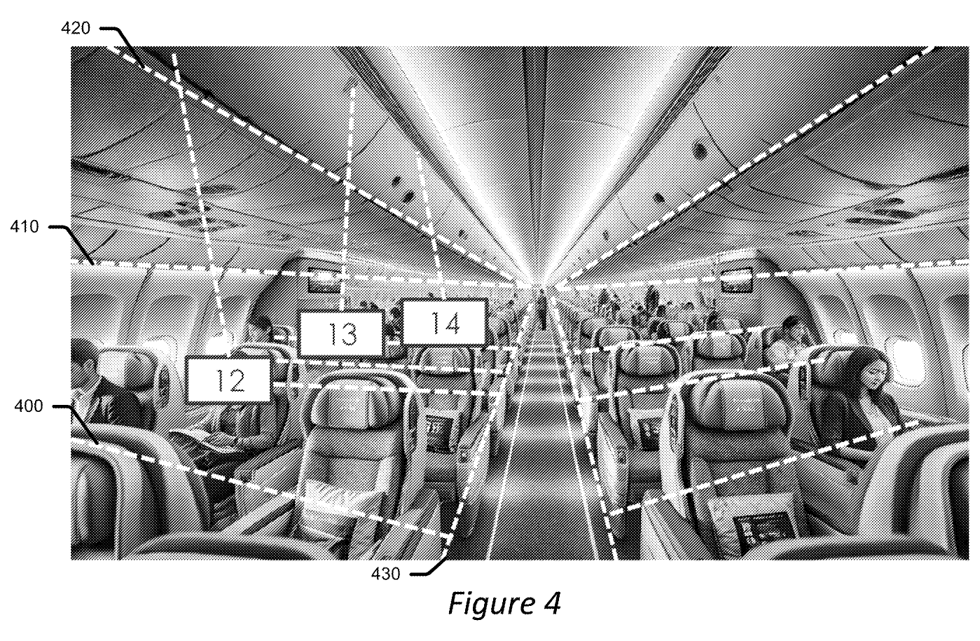

Other features observed in processed video frames from the AR headset may also be identified relative to the 3D model and LOPA to provide the AR headset manager the precise location and pose of the AR headset. For instance, the AR headset manager can identify cabin panel edge locations 210, seat number placards 202, seat/cabin feature location recognition 206, and other significant features such as the edges of overhead storage bins. FIG. 4 provides an illustration of reference axes which the AR headset cabin positioning model 500 defines in the cabin based on seat placards and arrangement of seats and aisles in accordance with various embodiments of the present disclosure. The model 500 operates to process video frames received from the AR headset to identify location and meaning of seating placards, such as those labeled 12, 13, and 14, which are mounted on overhead structures within the cabin. These placards serve along with the arrangement and orientation of viewed seating and aisles serve as various references for determining the precise position of the AR headset within the cabin environment.

The RF transceivers may include a plurality of WiFi transceivers, Bluetooth transceivers, and/or RF beacons having locations in the cabin that are known to the AR headset cabin positioning model.

The AR headset manager also use RF positioning operations to approximate the location of the AR headset, using for example, received signal strength measurements and/or triangulation of RF signals received from known locations of beacons 208, locations of WAPs 200, and/or Bluetooth transceivers 212 at seat displays. However, these RF positioning operations may not be sufficiently accurate especially when performed in the noisy RF environment of an aircraft cabin.

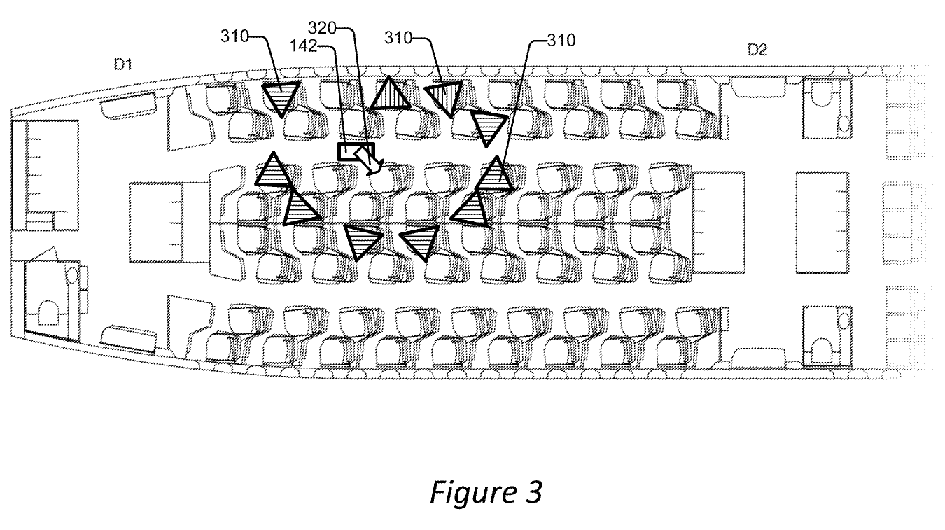

In FIG. 3, the video feed from the AR headset is processed through the AR headset cabin positioning model 500 (as depicted in FIG. 5) to ascertain the position of the AR headset relative to various cabin features, such as passenger seats. FIG. 3 depicts seats arranged within the cabin, cabin doors D1 and D2, bulkheads and other structures of the cabin. Due to the inherent symmetry of the cabin, certain patterns may repeat in different spaced-apart regions. This repetition can cause the AR headset cabin positioning model 500 to produce multiple potential matches, or false positives, for the headset's location, as multiple areas within the cabin may present sufficiently similar views to the AR headset.

To mitigate this issue, RF ranging technology can be employed to determine a general location within the cabin. For example, in FIG. 3 the RF ranging based location of an XR headset 142 is generally determined to be in an area indicated by possible locations 310. This general location can then be used to narrow down the area that the AR headset cabin positioning model 500 considers when identifying the headset's precise location. By restricting the search area within the model 500, the likelihood of false positives is reduced, and the computational complexity of processing each subsequent video frame from the AR headset's camera is significantly decreased (e.g., search only in a subset of the model 500 relevant to the general (RF approximated) location within the cabin). The model 500 is then used to more accurately determine the location of the headset 142 as being at 320, where the location determined by the model 500 identifies both the spatial location within the cabin and a direction in which the crew member is looking. This approach not only enhances the accuracy of the positioning model but also improves the overall efficiency of the system.

The integration of such advanced positioning technology into IFE systems represents a significant advancement in the tools available to cabin crew. It ensures that the augmented information overlay is relevant to where the crew member is looking and can be accurately aligned relative to what the crew member sees, thereby reducing the likelihood of errors and enhancing the overall effectiveness of the AR system. This technology not only improves the operational efficiency of the crew but also contributes to a safer and more streamlined in-flight experience for passengers. As the aviation industry continues to embrace innovative technologies, the use of AR headsets equipped with advanced positioning technologies is likely to become a standard practice, setting new benchmarks for service and safety in the skies.

It is noted that although various components and operations are described in the example of a AR headset, any type of computing device with a display can be used with embodiments herein. For example, an AR device can include an AR headset (e.g., AR glasses, AR contacts, etc.), a tablet computer, a smartphone, or other portable/transportable computing device. Accordingly, the term "AR device" includes AR headsets and other types of computing devices that can be configured to operate in accordance with embodiments herein.

### Crew Use of AR Headset

Airlines are under increased pressure to staff flights with less crew who are responsible for more passengers. Despite these pressures, airlines are also motivated to provide more personalized treatment for passengers, especially for premium ticketed passengers and certain loyalty status passengers.

Operations disclosed herein by the AR headset manager 140 and IFE controller 160 can provide much needed assistance to aircraft crew members with performing their duties using AR headsets 142. The AR headsets 142 are configured to allow crew members to view the cabin and interact with passengers while being assisted by computer generated AR information which is displayed through, e.g., see-through display devices of, the AR headsets 142 as an visual overlay on the crews' views. The integration of AR headsets into the daily operations of cabin crew has the potential to revolutionize the personalization and efficiency which crew can provide to in-flight services and safety procedures. AR headsets can provide event-driven or continuously updated AR information overlays, allowing crew members to access passenger details, seating arrangements, and special requests without needing to consult physical documents. This AR information view enhances the crews ability to time-efficiently provide personalized services ensuring that passenger preferences and needs are met promptly and accurately.

Further scenarios and related operational embodiments are now described for providing AR information to crew members.

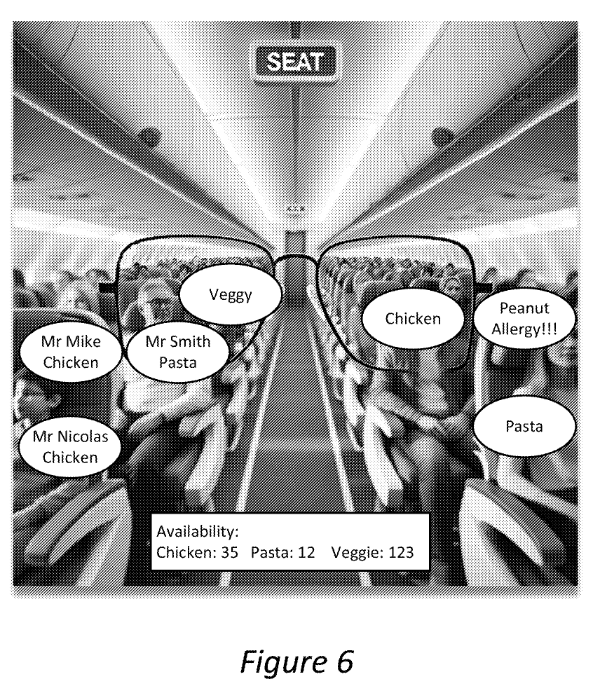

FIGS. 6-9 illustrate example types of passenger information that could be displayed through an AR headset 142 to assist crew members providing services to passengers.

In these examples, the AR headset manager 140 determines location of one of the AR headsets 142 worn by a crew member relative to physical features of the cabin, and identifies a passenger in video captured by a camera of the AR headset 142 based on the determined location of the AR headset 142. The AR headset manager 140 then provides the identity of the passenger and the determined location of the AR headset 142 to the IFE controller 160.

The IFE controller 160 is operative to obtain passenger information based on the identity of the passenger, generate AR information based on the passenger information and the determined location of the AR headset 142, and to communicate the AR information through the at least one cabin communication network to the AR headset 142 for display as an augmented reality image overlaid on a real-world image viewed through the AR headset 142.

Referring initially to FIG. 5, example types of passenger information that can be displayed as AR information through an AR headset 142 can include a passenger's airline loyalty status, service requests from identified passengers, messages sent by identified passengers to crew, and special needs of identified passengers (e.g., dietary restrictions, locations of infants, disabilities, etc.).

As illustrated in FIG. 5, the AR information can be displayed through the AR headset 142 with visual associations to the associated passengers by, for example, anchoring the AR information to be displayed as a visual overlay proximately located to where the particular passengers are viewed through the AR headset 142. Examples illustrated in FIG. 5 include that seat 8E is requesting the purchase or has purchased a particular drink, seat 25D is occupied by Mr. Smith who is a customer VIP status, seat 36B has sent a displayed message to crew, seat 30A is reaching a platinum loyalty status level, seat 12C is requesting assistance (the particular assistance needs may be indicated through the AR information), and seat 2B is occupied by an infant.

Referring to FIG. 6, example types of passenger information that can be displayed as AR information through an AR headset 142 can include a passenger's food/drink preferences, pre-paid or pre-selected meals/drinks, food allergies or sensitivities, and relevant information such as current remaining stock of items.

As illustrated in FIG. 6, the AR information can be displayed through the AR headset 142 with visual associations to the associated passengers by, for example, anchoring the AR information to be displayed as a visual overlay proximately located to where the particular passengers are viewed through the AR headset 142. Examples illustrated in FIG. 6 include that Mr. Nicolas and Mr. Mike are requesting a chicken meal, Mr. Smith is requesting a pasta meal, unnamed passengers have requested veggie, chicken, and pasta meals, and that one passenger has a peanut allergy staff must be cautious about. The example illustrated in FIG. 6 also shows the live numbers of remaining items onboard the flight as items are requested and/or purchased.

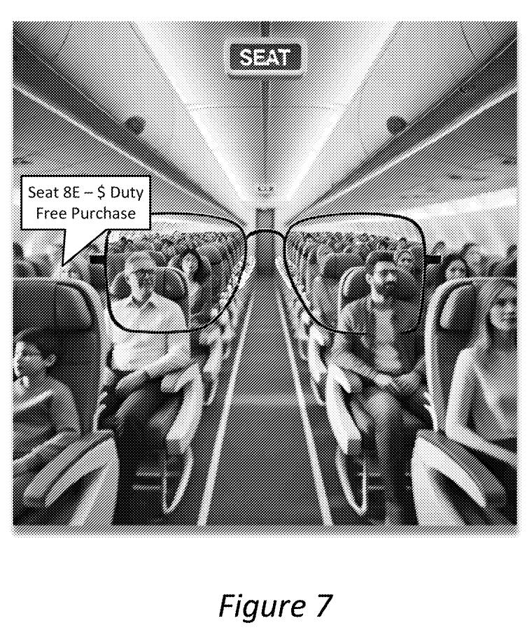

Referring to FIG. 7, example types of passenger information that can be displayed as AR information through an AR headset 142 can include a passenger's purchase of items while flying. Examples illustrated in FIG. 7 include that the passenger in seat 8E made a duty free purchase which the cabin crew may be informed of to help fulfill the purchase.

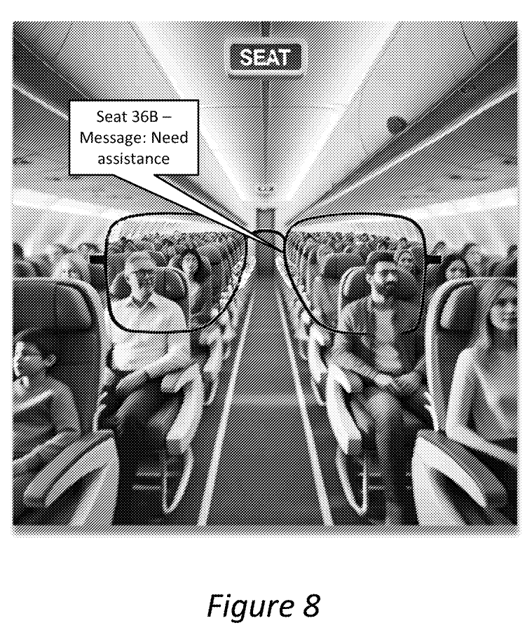

Referring to FIG. 8, example types of passenger information that can be displayed as AR information through an AR headset 142 can include a passenger's disabilities or need for assistance. Examples illustrated in FIG. 7 include that the passenger in seat 36B is in need of assistance from a cabin crew member.

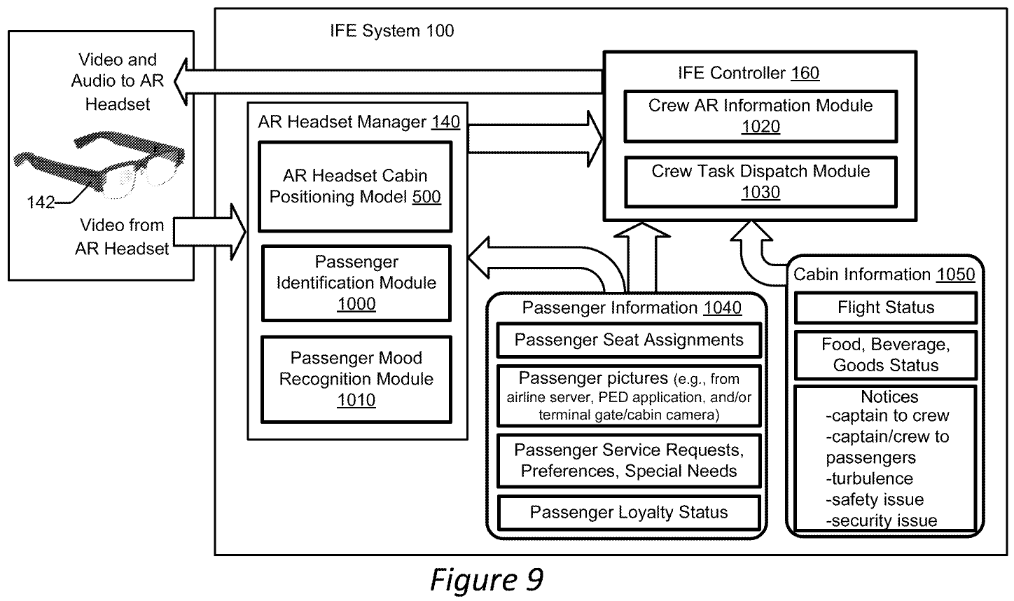

FIG. 9 illustrates a diagram of functional modules of the IFE system 100, including the AR headset manager 140 and the IFE controller 160.

The AR headset manager 140 can include the AR headset cabin positioning model 500 described above, a passenger identification module 1000, and a passenger mood recognition module 1010. The RFP controller 160 can include a crew AR information module 1020 and a crew task dispatch module 1030.

The AR headset manager 140 and the IFE controller 160 can operate using passenger information 1040 which can include data from a passenger manifest or other repository. The passenger information 1040 may, for example, include passenger seat assignments, passenger pictures (e.g., stored in an airline server, a airline application hosted on a passenger electronic device (PED), and/or a camera located at a terminal gate and/or in the cabin (e.g., at a cabin entrance), passenger service requests, passenger preferences, passenger special needs, and passenger airline loyalty status.

The AR headset manager 140 and the IFE controller 160 may also operate using cabin information 1050 which may include current flight status, availability status and characteristics of food, beverage and other goods, messages exchanged between captain and crew and/or between crew and passengers, and automatically generated notices relating to turbulence, safety issues, and/or security issues.

Example operations of these and other functional modules will now be described by way of examples and various embodiments.

Various embodiments are directed to an IFE system including an IFE controller and an AR device manager. The IFE controller operative to route entertainment content through at least one cabin communication network to SVDUs and/or to PEDs. The AR device manager is operative to determine location of an AR device relative to physical features of the cabin, to identify a passenger in video captured by a camera of the AR device based on the determined location of the AR device, and to provide the identity of the passenger and the determined location of the AR device to the IFE controller. The IFE controller is further operative to obtain passenger information based on the identity of the passenger, to generate AR information based on the passenger information and the determined location of the AR device, and to communicate the AR information through the at least one cabin communication network to the AR device for display as an augmented reality image overlaid on a real-world image viewed through the AR device.

In some embodiments, the passenger information 1040 may include information which may be used to look up the identity of a passenger and information associated with the identified passenger.

The AR device manager may be further operative to use the determined location of AR device to determine an aircraft seat identifier and/or seat location within the cabin where AR device is looking and to responsively look up passenger identity in a manifest indicating passenger seat assignments.

The AR device manager may be further operative to compare real-time passenger images captured in video from the AR device to a defined set of passenger pictures with associated passenger identifiers to identify a passenger viewed by the camera of the AR device and provide the identity of the passenger to the IFE controller to generate AR information based on the identity of the passenger.

The AR device manager may also enhance accuracy of the comparison by weighting identification decisions which identify most likely passenger candidates based on which passengers are assigned to seats identified as being located within a central area of a field of view of the camera at the determined location of the AR device.

Pictures of the passengers to be used for identifying passengers may be accessed in multiple ways.

The AR device manager may receive passenger pictures through communications with airline applications residing on passenger electronic devices, and add the received passenger pictures to the set of passenger pictures.

The AR device manager may alternatively or additionally be operative to receive passenger pictures through communications with at least one camera located at a terminal check-in counter, terminal check-in kiosk, and/or terminal gate kiosk. The at least one camera provides pictures and associated passenger identities to the AR device manager. The AR device manager is also operative to add the received passenger pictures and associated passenger identities to the set of passenger pictures.

The AR device manager may alternatively or additionally receive passenger pictures through communications with a camera located at an aircraft cabin entrance as passengers board the aircraft. The AR device manager may associate a sequence order of the received passenger pictures with a sequence order of passenger identities who have been reported by a terminal gate kiosk as having scanned boarding passes before walking toward the aircraft entrance to board the aircraft. Additionally, the AR device manager adds the received passenger pictures and associated passenger identities to the set of passenger pictures.

The AR device manager may alternatively or additionally use passenger identifies contained in a passenger manifest to query a government database containing pictures and associated identities of persons to retrieve pictures of passengers in the passenger manifest and add the received passenger pictures and associated passenger identities to the set of passenger pictures.

The AR device manager may be configured to retain the passenger pictures only for duration of a flight by operationally responding to arrival at a destination airport to perform operations that delete the passenger pictures from memory of the AR device manager.

Passenger identity privacy is very important to some airlines. Therefore, anonymization of passenger identifiers may be required.

In such embodiments, the AR device manager may also anonymize pictures by generating passenger facial feature metrics characterizing facial features extracted from the pictures. The AR device manager also stores the generated passenger facial feature metrics and operationally deletes the photos from memory of the AR device manager.

In some of these embodiments, operations by the AR device manager to identify a passenger in video captured by a camera of the AR device based on the determined location of the AR device include to compare the stored passenger facial feature metrics to newly captured facial feature metrics generated from images of a passenger captured by the camera to identify matches.

Various information associated with the identified passengers may then be presented to cabin crew members on the AR headset in multiple ways.

In some embodiments, the IFE controller is further operative to obtain a passenger service request associated with the identity of the passenger and generate the AR information to indicate the passenger service request for view as an overlay displayed by the AR device with a visual association to the identified passenger viewed by a crew member who is wearing the AR device.

The IFE controller may also obtain a request associated with the identity of the passenger and generate the AR information to indicate the passenger service request for view as an overlay displayed by the AR device with a visual association to the identified passenger viewed by a crew member who is wearing the AR device.

Passenger familiarity with crew members and vice-versa may also be important to passenger satisfaction and comfort. Therefore, ensuring passengers continue to interact with the crew members they are most familiar with may be beneficial in high stress environments like long airplane travel, unexpected flight delays, turbulence, etc. Additionally, some crew members may have expertise in providing certain services or handling certain scenarios, such as language proficiencies (e.g., spoken languages, sign languages, etc.), knowledge of medical condition diagnosis and assistive procedures, experience with assisting agitated passengers, etc.

In some of these embodiments, the IFE controller may operate to track interactions of identified crew members with identified passengers, and update a log file to indicate the tracked interactions. The IFE controller may operate to prioritize assignment of tasks relating to a particular identified passenger to one of the crew members who is indicated by the log file as having interacted with the particular identified passenger.

The IFE controller may also track types of services provided by identified crew members to the identified passengers, and update the log file to indicate the tracked services. The IFE controller may also prioritize future assignment of which crew members are tasked to provide which of the types of services to which of the passengers based on the log file, and generate AR information distributed to AR devices worn by the crew members indicating which types of services are assigned to individual ones of the crew members to provide to indicated ones of the passengers.

For example, when an identified crew member has interacted with an identified passenger to provide services, answer questions, etc., further requests initiated by that passenger can be delegated to the that crew member for assistance. Delegation of the further requests may include providing AR information to the identified crew member’s AR headset that identifies seat location and name of the identified passenger, what service or other assistance has been requested (if known), and a summary of information which may be relevant for the identified crew member to know when assisting that passenger (e.g., history of services provided to the passenger, airline loyalty status, preferred language, travel itinerary, status of next flight and terminal gate information for passenger’s itinerary, prior travel itinerary(ies) and any associated problems (e.g., delays/cancellations/etc.), existing passenger’s Internet connectivity privilege, identification of any other passenger(s) associated with that passenger, identification of history of services provided to the other associated passenger(s), flight information, etc.).

Referring to FIG. 9, the crew task dispatch module 1030 may include an artificial intelligence model (e.g., machine learning model with associated machine learning operations) which operates to perform the assignment of crew member tasks to particular crew members based on one or more of the above, including: identified crew member skills; determined/tracked passenger familiarity with crew members and/or vice-versa; determined/tracked interactions of identified crew members with identified passengers; etc.

The crew task dispatch module 1030 may be trained using multiple methods, such as using machine learning training. In these embodiments, the IFE controller and/or the AR headset manager includes a machine learning training model operative in a training mode to train the crew task dispatch module based on identifying correlations between multiple inputs which may be static during the training mode or which change dynamically during a flight, such as any of the following: previous tasks performed by a crew member, passengers who crew members have interacted with, specialties or skills of crew members (e.g., languages spoken, sign language proficiency, etc.), flight information (e.g.,, current phase of a flight, time to destination, anticipated turbulence, anticipated passenger seated requirement, etc.), current cabin position of the crew members, etc. The machine learning training model may be trained responsive to a stream of video frames received from a camera of a training AR headset transported by a person along cabin aisles, galleys, and defined cabin areas to enable improved localization of AR headsets within the cabin based on video captured cabin features.

The machine learning training model may be operative in the training mode to train the crew task dispatch module to indicate a list of tasks for a specific crew member in an order of highest priority to lowest priority.

The machine learning training model may be further operative in the training mode to train the crew task dispatch module based on comparing tasks that need to be completed to tracked locations of crew members within the cabin and a layout of passenger accommodations (e.g., proximity of a crew member to a passenger needing services).

Passengers’ ability to complete purchases need to be as simplified and easy as possible. Passenger information 1040 associated with the identified passenger may also include payment information to allow for card free purchases even when the passenger is not seated in their assigned seat.

The IFE controller may also obtain credit card information as part of the obtained passenger information based on the identity of the passenger, and use credit card information to complete a purchase of a service requested by the identified passenger.

Further Definitions and Embodiments:

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being "connected", "coupled", "responsive", or variants thereof to another element, it can be directly connected, coupled, or responsive to the other element or intervening elements may be present. In contrast, when an element is referred to as being "directly connected", "directly coupled", "directly responsive", or variants thereof to another element, there are no intervening elements present. Like numbers refer to like elements throughout. Furthermore, "coupled", "connected", "responsive", or variants thereof as used herein may include wirelessly coupled, connected, or responsive. As used herein, the singular forms "a", "an" and "the" are intended to include the plural forms as well, unless the context clearly indicates otherwise. Well-known functions or constructions may not be described in detail for brevity and/or clarity. The term "and/or" includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms "comprise", "comprising", "comprises", "include", "including", "includes", "have", "has", "having", or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation "e.g.", which derives from the Latin phrase "exempli gratia," may be used to introduce or specify a general example or examples of a previously mentioned item, and is not intended to be limiting of such item. The common abbreviation "i.e.", which derives from the Latin phrase "id est," may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as "circuitry," "a module" or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the following examples of embodiments and their equivalents, and shall not be restricted or limited by the foregoing detailed description.

What is claimed is:

1. An aircraft inflight entertainment (IFE) system comprising:
an IFE controller operative to route entertainment content through at least one cabin communication network to seat video display units (SVDUs) and/or to portable electronic devices (PEDs); and
an augmented reality (AR) device manager operative to determine location of an AR device relative to physical features of the cabin, to identify a passenger in video captured by a camera of the AR device based on the determined location of the AR device, and to provide the identity of the passenger and the determined location of the AR device to the IFE controller,
wherein the IFE controller is further operative to obtain passenger information based on the identity of the passenger, to generate AR information based on the passenger information and the determined location of the AR device, and to communicate the AR information through the at least one cabin communication network to the AR device for display as an augmented reality image overlaid on a real-world image viewed through the AR device.

2. The IFE system of claim 1, wherein the AR device manager is further operative to:
use the determined location of AR device to determine an aircraft seat identifier and/or seat location within the cabin where AR device is looking and to responsively lookup passenger identity in a manifest indicating passenger seat assignments.

3. The IFE system of claim 1, wherein the AR device manager is further operative to:
compare real-time passenger images captured in video from the AR device to a defined set of passenger pictures with associated passenger identifiers to identify a passenger viewed by the camera of the AR device;
provide the identity of the passenger to the IFE controller to generate AR information based on the identity of the passenger.

4. The IFE system of claim 3, wherein the AR device manager is further operative to:
enhance accuracy of the comparison by weighting identification decisions which identify most likely passenger candidates based on which passengers are assigned to seats within a central area of a field of view of the camera at the determined location of the AR device.

5. The IFE system of claim 3, wherein the AR device manager is further operative to:
receive passenger pictures through communications with airline applications residing on passenger electronic devices; and
add the received passenger pictures to the set of passenger pictures.

6. The IFE system of claim 3, wherein the AR device manager is further operative to:
receive passenger pictures through communications with at least one camera located at:
a terminal check in counter;
terminal check in kiosk; and/or
terminal gate kiosk,
wherein the at least one camera provides pictures and associated passenger identities to the AR device manager; and
add the received passenger pictures and associated passenger identities to the set of passenger pictures.

7. The IFE system of claim 1, wherein the AR device manager is further operative to:
receive passenger pictures through communications with a camera located at an aircraft cabin entrance as passengers board the aircraft;
associate a sequence order of the received passenger pictures with a sequence order of passenger identities who have been reported by a terminal gate kiosk as having scanned boarding passes before walking toward the aircraft entrance to board the aircraft; and
add the received passenger pictures and associated passenger identities to the set of passenger pictures.

8. The IFE system of claim 3, wherein the AR device manager is further operative to:
use passenger identifies contained in a passenger manifest to query a government database containing pictures and associated identities of persons to retrieve pictures of passengers in the passenger manifest; and
add the received passenger pictures and associated passenger identities to the set of passenger pictures.

9. The IFE system of claim 3, wherein the AR device manager is further operative to:
retain the passenger pictures only for duration of a flight by responding to arrival at a destination airport to perform operations that delete the passenger pictures from memory of the AR device manager.

10. The IFE system of claim 1, wherein the AR device manager is further operative to:
anonymize pictures by generating passenger facial feature metrics characterizing facial features extracted from the pictures;
store the generated passenger facial feature metrics; and
delete the photos from memory of the AR device manager.

11. The IFE system of claim 10, wherein the AR device manager operation to identify a passenger in video captured by a camera of the AR device based on the determined location of the AR device comprises to:
compare the stored passenger facial feature metrics to newly captured facial feature metrics generated from images of a passenger captured by the camera to identify matches.

12. The IFE system of claim 1, wherein the IFE controller is further operative to:
obtain a passenger service request associated with the identity of the passenger and generate the AR information to indicate the passenger service request for view as an overlay displayed by the AR device with a visual association to the identified passenger viewed by a crew member who is wearing the AR device.

13. The IFE system of claim 1, wherein the IFE controller is further operative to:
obtain a request associated with the identity of the passenger and generate the AR information to indicate the passenger service request for view as an overlay displayed by the AR device with a visual association to the identified passenger viewed by a crew member who is wearing the AR device.

14. The IFE system of claim 1, wherein the IFE controller is further operative to:
track interactions of crew members with identified passengers;
update a log file based on the tracked interactions; and
prioritize assignment of tasks relating to a particular identified passenger to one of the crew members who is indicated by the log file as having interacted with the particular identified passenger.

15. The IFE system of claim 1, wherein the IFE controller is further operative to:
track types of services provided by crew members to the identified passengers;
update the log file based on the tracked services;
prioritize future assignment of which crew members are to provide which of the types of services to which of the passengers based on the log file; and
generate AR information distributed to AR devices worn by the crew members indicating which types of services are assigned to individual ones of the crew members to provide to indicated ones of the passengers.

16. The IFE system of claim 1, wherein the IFE controller is further operative to:
obtain credit card information as part of the obtained passenger information based on the identity of the passenger; and
use credit card information to complete a purchase of a service requested by the identified passenger.

17. A method for operating an aircraft inflight entertainment (IFE) system comprising an IFE controller and augmented reality (AR) device manager, the method comprising:
the IFE controller routing entertainment content through at least one cabin communication network to seat video display units (SVDUs) and/or to portable electronic devices (PEDs);
the AR device manager determining location of an AR device relative to physical features of the cabin, to identify a passenger in video captured by a camera of the AR device based on the determined location of the AR device, and to provide the identity of the passenger and the determined location of the AR device to the IFE controller; and
the IFE controller:
obtaining passenger information based on the identity of the passenger,
generating AR information based on the passenger information and the determined location of the AR device, and
communicating the AR information through the at least one cabin communication network to the AR device for display as an augmented reality image overlaid on a real-world image viewed through the AR device.
